(19) United States
(12) Patent Application Publication
(10) Pub. No.: US 2016/0163319 A1
(43) Pub. Date: Jun. 9, 2016

(54) DETERMINING A DEGREE OF AUTOMATICITY FOR A MOBILE SYSTEM OPERATION

(71) Applicant: TOYOTA JIDOSHA KABUSHIKI KAISHA, Toyota-shi (JP)

(72) Inventors: Rahul PARUNDEKAR, Sunnyvale, CA (US); John Mark AGOSTA, Palo Alto, CA (US); Rama VUYYURU, San Jose, CA (US); Daisuke HIROKI, Toyota-shi (JP)

(21) Appl. No.: 14/564,938

(22) Filed: Dec. 9, 2014

(51) Int. Cl. G10L 17/22

(52) U.S. Cl. CPC G10L 17/22

(57) ABSTRACT

The disclosure includes a system and method for determining a degree of automaticity for a mobile system operation. The system includes a processor and a memory storing instructions that, when executed, cause the system to: receive sensor data from one or more sensors communicatively coupled to the processor, determine a current state of a mobile system based on the sensor data, determine that the current state of the mobile system is a candidate to be changed to a target state based on a comparison of the current state to the target state, and determine a degree of automaticity for an operation to change the current state of the mobile system to the target state.

### BACKGROUND

The specification relates to determining a degree of automaticity for a mobile system operation.

A vehicle can include manual sensors that users manipulate to control functions. For example, a steering wheel can include buttons for controlling the volume for the radio. The vehicle can also include some automatic functions, for example, automatic headlights that adjust the level of brightness based on light levels. While some of the functions may be automatic, user input is still required for some of the other functions, which can be dangerous depending on how long the user is distracted from viewing the road.

### SUMMARY

According to one innovative aspect of the subject matter described in this disclosure, a system includes a processor and a memory storing instructions that, when executed, cause the system to: receive sensor data from one or more sensors communicatively coupled to a processor-based computing device of a mobile system, determine a current state of the mobile system based on the sensor data, determine that the current state of the mobile system is a candidate to be changed to a target state based on a comparison of the current state to the target state, and determine a degree of automaticity for an operation to change the current state of the mobile system to the target state.

In general, another innovative aspect of the subject matter described in this disclosure may be embodied in methods that include: receiving sensor data from one or more sensors communicatively coupled to a processor-based computing device, determining a current state of a mobile system based on the sensor data, determining that the current state of the mobile system is a candidate to be changed to a target state based on a comparison of the current state to the target state, and determining, by a processor-based computing device programmed to perform the determining, a degree of automaticity for an operation to change the current state of the mobile system to the target state. Other aspects include corresponding methods, systems, apparatus, and computer program products.

In general, yet another innovative aspect of the subject matter described in this disclosure may be embodied in methods that include: receiving sensor data from one or more sensors communicatively coupled to a processor-based computing device, determining a current state of a mobile system based on the sensor data, determining that the current state of the mobile system is a candidate to be changed to a target state based on a comparison of the current state to the target state, determining, by the processor-based computing device programmed to perform the determining, a degree of automaticity for an operation to change the current state of the mobile system to the target state, performing the operation based on the degree of automaticity, receiving a verbal response from a user, determining a reaction from the user to at least one of the operation and the degree of automaticity based on natural language processing of the verbal response, and modifying at least one of the target state and the degree of automaticity based on the reaction from the user.

These and other implementations may each optionally include one or more of the following operations and features. For instance, the operations further include: performing the operation according to the degree of automaticity, determining a user manually overriding the operation by stopping the operation or reversing the operation, and modifying at least one of the target state and the degree of automaticity based on the user manually overriding the operation; performing the operation according to the degree of automaticity, determining a user manually overriding the operation by modifying a target setting associated with the target state to a new setting, and modifying the target state by replacing the target setting with the new setting; determining whether performing the operation would create a safety hazard and responsive to determining that performing the operation would create the safety hazard, determining that the degree of automaticity is to not perform the operation; storing a first record of sensor data responsive to a user performing a manual operation and determining the target state based on the sensor data in the record; and storing a second record of sensor data a predetermined amount of time before the user performs the manual operation, where determining the target state includes comparing the first record of sensor data to the second record of sensor data.

For instance, the features include: the degree of automaticity including asking a user for permission to perform the operation, and generating audio for playback in a speaker of the mobile system to ask the user for permission to perform the operation, receiving a verbal response to the audio from the user, determining whether the verbal response includes permission to perform the operation, and responsive to the verbal response including permission to perform the operation, performing the operation; the degree of automaticity including asking a user for permission to perform the operation, and generating graphical data for displaying a user interface that includes a request for permission to perform the operation; the degree of automaticity including asking a user for permission to perform the operation a first time, and responsive to the user providing permission, performing the operation automatically each subsequent time that the current state of the mobile system is determined to be the candidate to be changed to the target state; and the target state including a first setting associated with a first degree of automaticity and a second setting associated with a second degree of automaticity, where the first degree of automaticity is different from the second degree of automaticity.

The disclosure is particularly advantageous in a number of respects. For example, the system performs operations in a vehicle for the user with a desired degree of automaticity, thereby creating a personalized agent-like user experience in the vehicle where the automatic operation would approximate the user desire. As a result, the user can have a more satisfying experience and can focus on driving. This makes driving safer for the user and other people on the road.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for determining a degree of automaticity for a vehicle operation.

FIG. 2 is a block diagram illustrating an example automaticity device.

FIG. 3 is a graphic representation of an example user interface for asking a user for permission to perform an operation.

FIG. 4 is a flowchart of an example method for determining a degree of automaticity for a vehicle operation.

FIG. 5 is a flowchart of an example method for modifying a degree of automaticity based on a user's response to a vehicle operation.

### DETAILED DESCRIPTION

### Example System Overview

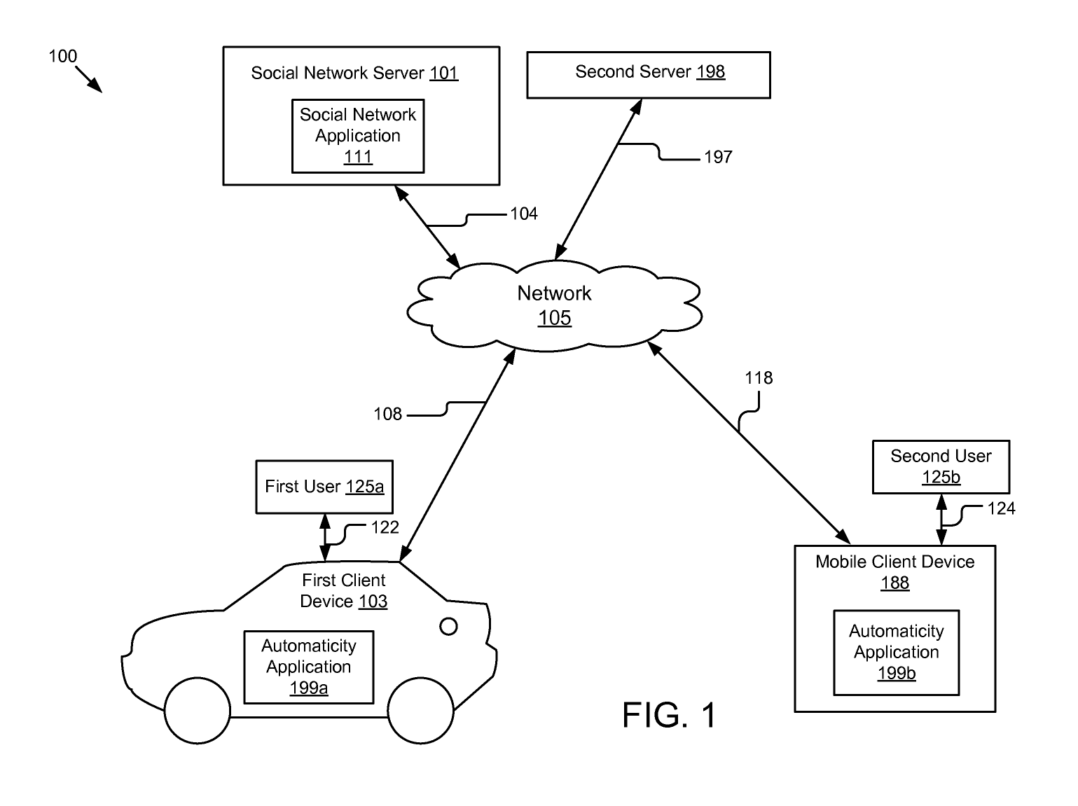

FIG. 1 is a block diagram illustrating an example system 100 for determining a degree of automaticity for a mobile system operation. The system 100 includes a first client device 103, a mobile client device 188, a social network server 101, and a second server 198. The first client device 103 and the mobile client device 188 can be accessed by users 125a and 125b (also referred to herein individually and collectively as “user 125”), via signal lines 122 and 124, respectively. In the illustrated example, these entities of the system 100 may be communicatively coupled via a network 105.

The first client device 103 and the mobile client device 188 in FIG. 1 can be used by way of example. While FIG. 1 illustrates two client devices 103 and 188, the disclosure applies to a system architecture having one or more client devices 103, 188. Furthermore, although FIG. 1 illustrates one network 105 coupled to the first client device 103, the mobile client device 188, the social network server 101, and the second server 198, in practice one or more networks 105 can be connected. While FIG. 1 includes one social network server 101 and one second server 198, the system 100 could include one or more social network servers 101 and one or more second servers 198.

The network 105 can include a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices may communicate. In some implementations, the network 105 may include a peer-to-peer network. The network 105 may also be coupled to or include portions of a telecommunications network for sending data in a variety of different communication protocols. In some implementations, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, etc. In some implementations, the network 105 may include a global positioning system (GPS) satellite for providing GPS navigation to the first client device 103 or the mobile client device 188. In some implementations, the network 105 may include a GPS satellite for providing GPS navigation to the first client device 103 or the mobile client device 188. The network 105 may include a mobile data network for example, 3G, 4G, long-term evolution (LTE), Voice-over-LTE (“VoLTE”), or other mobile data network or combination of mobile data networks.

In some implementations, an automaticity application 199a can be operable on the first client device 103. The first client device 103 can include a mobile client device with a battery system. For example, the first client device 103 can include one of a vehicle (e.g., an automobile, a bus), or other mobile system including non-transitory computer electronics and a battery system. In some implementations, the first client device 103 may include a computing device that includes a memory and a processor. In the illustrated example, the first client device 103 is communicatively coupled to the network 105 via signal line 108.

In some implementations, an automaticity application 199b can be operable on the mobile client device 188. The mobile client device 188 may include a portable computing device that includes a memory and a processor, for example, a removable in-dash device, a laptop computer, a tablet computer, a mobile telephone, a personal digital assistant (PDA), a mobile e-mail device, a portable game player, a portable music player, or other portable electronic device capable of accessing the network 105. In some implementations, the mobile client device 188 may include a processor-based computing device. The mobile client device 188 may be a personal computer, network-connected home appliance, set top box, network-connected electronic digital assistant, etc. The automaticity applications 199a and 199b may be referred to herein individually and collectively as “automaticity application 199.” In some implementations, the automaticity application 199 may act in part as a thin-client application that may be stored on the first client device 103 and in part as components that may be stored on the mobile client device 188. In the illustrated example, the mobile client device 188 is communicatively coupled to the network 105 via signal line 118. Although the automaticity application 199 is described below with reference to determining a degree of automaticity for a vehicle, in general the automaticity application 199 may determine a degree of automaticity for any mobile system. Examples of a mobile system include the first client device 103 and the mobile client device 188. In some implementations, a mobile system includes any non-stationary processor-based computer device.

In some implementations, the first user 125a and the second user 125b can be the same user 125 interacting with both the first client device 103 and the mobile client device 188. For example, the user 125 can be a driver sitting in the first client device 103 (e.g., a vehicle) and operating the mobile client device 188 (e.g., a smartphone). In some other implementations, the first user 125a and the second user 125b may be different users 125 that interact with the first client device 103 and the mobile client device 188, respectively. For example, the first user 125a could be a driver that drives the first client device 103 and the second user 125b could be a passenger that interacts with the mobile client device 188.

The automaticity application 199 can include software for determining a degree of automaticity for a mobile system operation. The automaticity application 199 receives sensor data from one or more sensors communicatively coupled to processor-based computing device. For example, the automaticity application 199 receives temperature readings from a thermometer inside the vehicle, audio information from an infotainment device, time from a clock, and/or other sensor data from one or more other suitable sensors. The processor-based computing device may be an onboard computer system of a vehicle or a processor device of a mobile client device 188. The automaticity application 199 determines a current state of the mobile system based on the sensor data. The current state may include information about the sensors in the mobile system at a particular time. For example, the mobile system is a vehicle and the automaticity application 199 determines that it is 80 degrees Fahrenheit inside the vehicle, and the user is listening to a morning news radio program at 7:55 a.m.

The automaticity application 199 determines that the current state of the mobile system may be a candidate to be changed to a target state based on a comparison of the current state to the target state. For example, the automaticity application 199 determines whether information associated with the parameters for the current state are different than one or more settings for the target state. For example, the automaticity application 199 determines that the target state for 7:55 a.m. is 70 degrees Fahrenheit inside the vehicle and the user listens to a morning news radio program. The automaticity application 199 determines that the current state may be a candidate to be changed to the target state because the temperature inside the vehicle is 10 degrees warmer than the target state.

The automaticity application 199 determines a degree of automaticity for an operation to change the current state to the target state. For example, the automaticity application 199 determines whether to automatically lower the temperature from 80 degrees to 70 degrees by turning on the air conditioning. Alternatively, the automaticity application 199 could ask the user's permission to turn on the air conditioning. The automaticity application 199 could ask for the user's permission by generating audio for playback in a speaker in the vehicle or by generating graphical data that may be displayed on the mobile client device 188.

The automaticity application 199 may modify the target state based on a user response to an operation. For example, if the user manually overrides an automatic operation by stopping the operation, reversing the operation, or changing the setting, the automaticity application 199 may change the setting for the target state or the degree of automaticity. Alternatively, if the user does nothing, the automaticity application 199 may determine that the user approves of the operation and the degree of automaticity.

In some implementations, the automaticity application 199 can be implemented using hardware including a field-programmable gate array (“FPGA”) or an application-specific integrated circuit (“ASIC”). In some other implementations, the automaticity application 199 can be implemented using a combination of hardware and software. The automaticity application 199 may be stored in a combination of the devices and servers, or in one of the devices or servers.

The social network server 101 can include a hardware server that includes a processor, a memory, and network communication capabilities. In the illustrated example, the social network server 101 is coupled to the network 105 via signal line 104. The social network server 101 sends and receives data to and from other entities of the system 100 via the network 105.

The social network server 101 includes a social network application 111. The social network application 111 may generate a social network. For example, the social network may include Facebook™, Google+™, LinkedIn™, Tinder™, or QQ™. A social network can include a type of social structure where the user 125 may be connected by a common feature. The common feature may include relationships/connections, e.g., friendship, family, work, an interest, etc. The common features may be provided by one or more social networking systems including explicitly defined relationships and relationships implied by social connections with other online users, where the relationships form a social graph. In some examples, the social graph can reflect a mapping of these users and how they can be related.

In some implementations, the social network application 111 generates a social network that may include information that the automaticity application 199 uses to generate user data. For example, the user may provide information to the social network application 111 that may be relevant to the automaticity application 199, for example, gender, height, and musical taste.

The second server 198 can include a server that provides data to the first client device 103, the mobile client device 188, or the automaticity application 199. The second server 198 can include an infotainment server for providing infotainment, a music server for providing streaming music services, a traffic server for providing traffic data, a map server for providing map data, a weather server for providing weather data, a power service server for providing power usage service (e.g., billing service), or a health server for providing health information.

The second server 198 may host and/or generate websites that provide one or more of the following network services: navigation instructions; streaming audio or video (for example, Pandora™, Spotify™, iTunes™, Google Play™, YouTube™, Netflix™, Hulu Plus™ Crackle™, Amazon™ Instant Video, Prime Instant Video, Digital Music Store, Prime Music App Store, etc.); microblogging (for example, Twitter™, Tumblr™, etc.); online chatting (for example, Google Chat™, Snapchat™, WhatsApp™, etc.); online content sharing (for example, Instagram™, Pinterest™, etc.); e-mail (for example, Gmail™, Outlook™, Yahoo! Mail™, etc.); file sharing (for example, Dropbox™, Google Drive™, MS OneDrive™, Evernote™, etc.); electronic calendar and scheduling (for example, Google™ Calendar, MS Outlook™, etc.); and health data sharing (for example, Fitbit™, Jawbone™, Nike+ Fuelband, etc.). In some implementations, a user may consume one or more of these network's services via an infotainment system of the vehicle.

### Example Automaticity Application

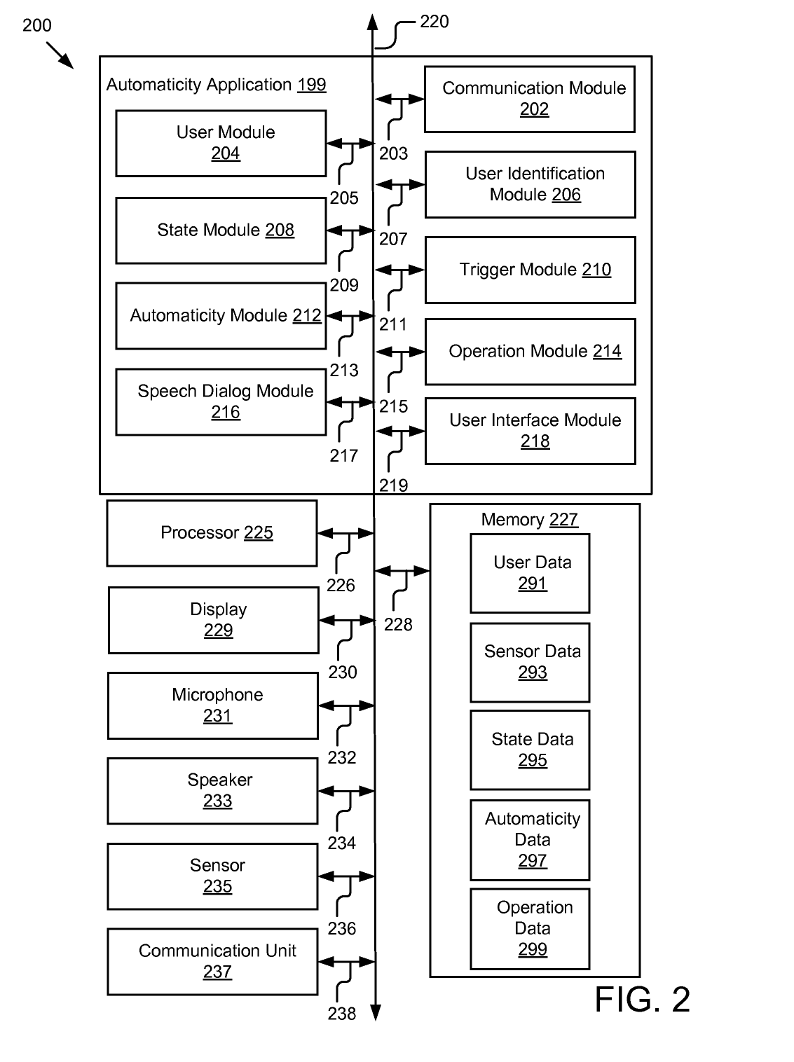

FIG. 2 is a block diagram illustrating an example automaticity device 200. The automaticity device 200 can be, or include, or be included in the first client device 103 or the mobile client device 188 of FIG. 1. FIG. 2 can include the automaticity application 199, a processor 225, a memory 227, a display 229, a microphone 231, a speaker 233, a sensor 235, and a communication unit 237. The components of the automaticity device 200 are communicatively coupled by a bus 220. In some implementations, the automaticity device 200 may be an element of one or more of the first client device 103 and the mobile client device 188.

The processor 225 includes an arithmetic logic unit, a microprocessor, a general-purpose controller, or some other processor array to perform computations and provide electronic display signals to a display device. The processor 225 processes data signals and may include various computing architectures including a complex instruction set computer (CISC) architecture, a reduced instruction set computer (RISC) architecture, a graphic processor unit (GPU) architecture or an architecture implementing a combination of instruction sets. Although FIG. 2 includes a single processor 225, multiple processors 225 may be included. Other processors, operating systems, sensors, displays, and physical configurations may be possible. The processor 225 is coupled to the bus 220 for communication with the other components via signal line 226.

The memory 227 stores instructions or data that may be executed by the processor 225. The instructions or data may include code for performing the techniques described herein. The memory 227 may include a dynamic random access memory (DRAM) device, a static random access memory (SRAM) device, flash memory, or some other memory device. In some implementations, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. The memory 227 is coupled to the bus 220 for communication with the other components via signal line 228.

As illustrated in FIG. 2, the memory 227 stores user data 291, sensor data 293, state data 295, automaticity data 297, and operation data 299.

The user data 291 includes information about the users, for example, a unique identifier, height, weight, user preferences, etc. The automaticity application 199 uses information about the user (e.g., the user's height) to determine user settings (e.g., a seat position based on the user's height). The automaticity application 199 uses information about the user, for example, the user's weight, to identify the user.

The sensor data 293 includes information about sensor readings. For example, the sensor data 293 includes sensor readings recorded at a particular time period. The automaticity application 199 uses the sensor data 293 to determine different states of the vehicle. For example, the automaticity application 199 determines an internal temperature in the vehicle to identify a current state.

The automaticity application 199 stores the state of the vehicle as state data 295. The state data 295 includes information about different states of the vehicle as a function of time. For example, the state data 295 may include a target state, which describes settings that the automaticity application 199 determines are desired by a user. The automaticity application 199 may also record user responses to the target state. For example, in response to the automaticity application 199 automatically turning on the air conditioning when the temperature reaches 80 degrees, the user may readjust the temperature to 80 degrees. The automaticity application may replace a temperature setting that is part of the state data 295 for the target state with the new target setting of 80 degrees.

The automaticity data 297 includes parameters of degrees of automaticity of a mobile system operation. In some implementations, the degrees of automaticity include: data establishing that an automatic operation not be performed; data establishing that a user be asked for permission each time before an operation is performed; data establishing that a user be asked for permission the first time an operation is performed and, if the user gives permission the first time, data establishing that the operation be automatically performed without asking the user permission each subsequent time that the operation is performed; data establishing that an operation be automatically performed while informing a user that the operation is being performed; data establishing that an operation be automatically performed without asking a user for permission or informing the user that the operation is being performed; and data estimating that a related operation be performed.

The operation data 299 includes operations performed by a user or the automaticity application 199. The operation data 299 may correspond to the automaticity data 297. For example, the automaticity data 297 includes asking the user for permission to perform the operation and the operation includes opening a window. Different mobile system operations may be associated with different degrees of automaticity. The operation data 299 may also include a user response to an operation performed by the automaticity application 199. For example, if the automaticity application 199 turns on the air conditioning to lower the temperature in the vehicle and the user turns off the air conditioning and opens a window, the automaticity application 199 updates the operation data 299 to include the user's preference for lowering the temperature by opening the window instead of using the air conditioning.

The display 229 can include hardware for displaying graphical data from the automaticity application 199. For example, the display 229 renders graphics for displaying a user interface that requests permission from the user to perform an operation. The display 229 is coupled to the bus 220 via 230.

The microphone 231 can include hardware for recording audio inside the vehicle. For example, the microphone 231 records audio spoken by a user in response to the automaticity application 199 performing an operation. The microphone 231 transmits the audio to the automaticity application 199 to convert the audio to words to determine the user's response to the operation and/or the degree of automaticity. The microphone 231 is coupled to the bus 220 via signal line 232.

The speaker 233 can include hardware for generating audio for playback. For example, the speaker 233 receives instructions from the automaticity application 199 to generate audio asking a user for permission to perform an operation. The speaker 233 converts the instructions to audio and generates the audio for the user. The speaker 233 is coupled to the bus 220 via signal line 234.

The sensor 235 can include a device that provides sensor data 293 about a state of the vehicle. The sensor 235 may be communicatively coupled to an onboard computer of a vehicle. The sensor 235 may include an infrared detector, a motion detector, a thermostat, etc. For example, the first client device 103 may include sensors for measuring one or more of a current time, a location (e.g., a latitude, longitude, and altitude of a location), an acceleration of a vehicle, a velocity of a vehicle, a fuel tank level of a vehicle, a battery level of a vehicle, etc. Alternatively or additionally, the sensor 235 can include a component or module of another system or device (e.g., radio, infotainment system, thermostat) that reports a status of the system or device to the automaticity device 200. In some implementations, the sensor 235 includes hardware for performing location detection, for example, a global positioning system (GPS), location detection through triangulation via a wireless network, etc. The sensor 235 provides information about at least one of a temperature inside the vehicle, a temperature outside the vehicle, a position of the seats, a radio station, an audio program, a window level, a level of illumination of car lights, a speed of windshield wipers, and other parameter or setting associated with the vehicle and/or any system, subsystem, or device included in or communicatively coupled to the vehicle. The sensor 235 is coupled to the bus 220 via signal line 236.

The communication unit 237 can include hardware that transmits and receives data to and from at least one of the first client device 103 and the mobile client device 188, depending upon where the automaticity application 199 is stored. The communication unit 237 is coupled to the bus 220 via signal line 238. In some implementations, the communication unit 237 includes a port for direct physical connection to the network 105 or to another communication channel. For example, the communication unit 237 includes a USB, SD, CAT-5, or similar port for wired communication with the first client device 103. In some implementations, the communication unit 237 includes a wireless transceiver for exchanging data with the first client device 103 or other communication channels using one or more wireless communication methods, including IEEE 802.11, IEEE 802.16, Bluetooth®, or another suitable wireless communication method.

In some implementations, the communication unit 237 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some implementations, the communication unit 237 includes a wired port and a wireless transceiver. The communication unit 237 also provides other conventional connections to the network 105 for distribution of files or media objects using standard network protocols including TCP/IP, HTTP, HTTPS, and SMTP, etc.

In some implementations, the automaticity application 199 includes a communication module 202, a user module 204, a user identification module 206, a state module 208, a trigger module 210, an automaticity module 212, an operation module 214, a speech dialog module 216, and a user interface module 218.

The communication module 202 can include code and routines for handling communications between the automaticity application 199 and other components of the automaticity device 200. In some implementations, the communication module 202 can include a set of instructions executable by the processor 225 to provide the functionality described below for handling communications between the automaticity application 199 and other components of the automaticity device 200. In some implementations, the communication module 202 can be stored in the memory 227 of the automaticity device 200 and can be accessible and executable by the processor 225.

The communication module 202 sends and receives data, via the communication unit 237, to and from one or more of the first client device 103, the mobile client device 188, the social network server 101, and the second server 198 depending upon where the automaticity application 199 may be stored. For example, the communication module 202 receives, via the communication unit 237, an audio program from the second server 198. The communication module 202 sends information about the audio program to the state module 208 for generating state data 295. The communication module 202 is coupled to the bus 220 via signal line 203.

In some implementations, the communication module 202 receives data from components of the automaticity application 199 and stores the data in the memory 227. For example, the communication module 202 receives data from the sensors 235, and stores it as sensor data 293 in the memory 227 as determined by the state module 208.

In some implementations, the communication module 202 may handle communications between components of the automaticity application 199. For example, the communication module 202 receives user data 291 from the user module 204 and transmits the user data 291 to the user identification module 206.

The user module 204 can include code and routines for receiving information about a user and generating user data 291. In some implementations, the user module 204 can include a set of instructions executable by the processor 225 to provide the functionality described below for receiving information about the user and generating user data 291. In some implementations, the user module 204 can be stored in the memory 227 of the automaticity device 200 and can be accessible and executable by the processor 225. The user module 204 is coupled to the bus 220 via signal line 205.

In some implementations, the user module 204 transmits instructions to the user interface module 218 to display a user interface for receiving information from a user. For example, the user interface may include fields for a user to provide a username, demographic information, the user's weight, the user's preferences, etc. The user module 204 receives user input from the user interface module 218 via the communication module 202 and generates user data 291 that is particular to a user. The user data 291 may be used by the user identification module 206 to identify which user is driving the vehicle.

In some implementations, the user module 204 also receives information from data sources outside of the automaticity device 200. The user module 204 may receive data from the social network application 111. For example, the social network application 111 may provide information about music genres or artists that a user likes, podcasts that the user listens to, etc. The user module 204 may add the information to the user data 291.

The user identification module 206 can include code and routines for identifying a user of a vehicle. In some implementations, the user identification module 206 can include a set of instructions executable by the processor 225 to provide the functionality described below for identifying the user of the vehicle. In some implementations, the user identification module 206 can be stored in the memory 227 of the automaticity device 200 and can be accessible and executable by the processor 225. The user identification module 206 is coupled to the bus 220 via signal line 207.

In some implementations, the user identification module 206 receives user data 291 from the user module 204 via the communication module 202 or retrieves user data 291 from the memory 227 about users that are associated with a vehicle. For example, a husband and wife may use the same vehicle. The user identification module 206 receives information about the user and identifies the user by comparing the information to the user data 291.

The user identification module 206 may identify the user of the vehicle based on sensor data 293 provided by the sensor 235. For example, seats in the vehicle may include scales for determining the user's weight. For the husband and wife couple, the weight difference may be significant enough to identify the user. In some implementations, the communication unit 237 may identify a wireless communication from a mobile device associated with the user, based on Bluetooth® communication, near-field communication (NFC), etc. The user identification module 206 may receive the communication from the communication unit 237 via the communication module 202. The user identification module 206 identifies the user based on the communication.

The user identification module 206 may transmit an identity of the user to the state module 208, the trigger module 210, or both via the communication module 202. The identity of the user may be important in determining a desire of the user where different users of the vehicle have different desires. The state module 208 may create state data 295 that is particular to the identified user. The trigger module 210 may use the identity of the user to retrieve the appropriate state data 295.

In some implementations, the user identification module 206 may identify multiple users of the vehicle that are using the vehicle at the same time. For example, the husband and wife may travel in the same vehicle together. The user identification module 206 may transmit the identities to the state module 208 for the state module 208 to determine state data 295 for each user.

The state module 208 can include code and routines for determining states and generating state data 295. In some implementations, the state module 208 can include a set of instructions executable by the processor 225 to provide the functionality described below for determining states and generating state data 295. In some implementations, the state module 208 can be stored in the memory 227 of the automaticity device 200 and can be accessible and executable by the processor 225. The state module 208 is coupled to the bus 220 via signal line 209.

In some implementations, the state module 208 generates state data 295 for a current state that includes sensor data 295 at a particular point in time and state data 295 for a target state that includes target settings based on desirability to a user.

The state module 208 generates state data 295 that includes a current state based on the sensor data 295. For example, the state module 208 identifies that at 8:52 a.m., when user A starts the vehicle, a current temperature outside the vehicle is 45 degrees Fahrenheit, a current temperature inside the car is 70 degrees Fahrenheit, user A adjusts the seat position to be as far back as allowed with the seat at a 45 degree angle, a map is configured to give user A driving directions to the state capitol, etc.

In some implementations, the state module 208 determines the current state data periodically, for example, every five minutes, every 30 minutes, every hour, etc. In some implementations, the state module 208 records the state data 295 each time there is a change in the current state. For example, the state module 208 records the state data 295 for the current state when a user turns on the windshield wipers.

In some implementations, the state module 208 determines state data 295 for a user in addition to state data 295 for a vehicle. The state module 208 may receive data from the second server 198 that the state module 208 uses to generate state data 295 for the user. For example, the state module 208 may receive health data from a health data server that includes how far the user has walked during a set period of time, the user's level of activity, the user's current heart rate, the user's skin temperature, or other data that may be used to generate state data 295 for the user. The state module 208 may use the health data to determine the user's current state. For example, the state module 208 may determine that the user's current state is tired and overheated.

In some implementations, the state module 208 determines state data 295 that includes a target state. The target state may include target settings. For example, the state module 208 determines that a user desires target settings for a mirror position, a podcast to be broadcast, a level of lighting inside the vehicle, etc. The state module 208 may determine the target state based on how a user manually configures settings, how a user manually overrides the settings, or generalized state data 295 for multiple users.

In some implementations, the state module 208 stores a record of the sensor data 293 each time the user performs a manual operation and determines the state data 295 for the target state based on the sensor data 293. The state module 208 may also store a second record of the sensor data 293 for a predetermined amount of time (e.g., five seconds, one minute, etc.) before the user performs the manual operation and compares the sensor data 293 to determine a difference. In some implementations where the user performs the manual operation to override an automatic operation performed by the operation module 214, the state module 208 stores a first record of the sensor data 293 a predetermined amount of time before the user overrides the automatic operation and a second record of the sensor data 293 after the user overrides the automatic operation to determine the difference between the sensor data 293. The state module 208 may use the difference to determine state data 295 with a new setting. It may be helpful for the state module 208 to update the state data 295 with the new setting to account for users with preferences that change over time.

In some implementations, the state module 208 determines a context for the state data 295. For example, the state module 208 may determine the context based on the time of day, the day of the week, whether the data corresponds to a holiday, etc. As a result, the state module 208 may determine that a target state during morning weekdays is a morning commute context, a target state during evening weekdays is an evening commute context, a target state during Saturday afternoon in the fall is a football context, a target state during major holidays is a family context, etc. The state module 208 may define the context based on a range of time. For example, a morning commute may be any time between 7:00 a.m. and 11:30 a.m. In some implementations, the state module 208 may determine the context based on the destination of the vehicle. For example, a user may request map directions for a gym from a second server 198. The state module 208 may determine, based on the request for map directions to the gym, that the context is that the user is about to work out.

The state module 208 may determine target states with different target settings based on a context. For example, a target setting for music during a morning commute is classical music. Conversely, a target setting for music during an evening commute is death metal. In another example, the state module 208 may determine a target state for a user that is independent of a time (e.g., a morning commute) or a date (e.g., holiday travel). For example, the state module 208 may determine that the context for a user's current state is being overheated due to exercise, and that the user's target state is a temperature of 65 degrees Fahrenheit in the vehicle. As a result, the user's target setting for temperature based on the user's current state of being overheated may be different from the target setting for temperature that would occur based on the time of day.

In some implementations where the user identification module 206 identifies that multiple users are in the vehicle, the state module 208 may determine target states for each user. The state module 208 may identify target states for each user that the users share in common, for example, a lighting level inside the vehicle or a music playlist that both users enjoy. The state module 208 may also identify target states for each user that do not affect the other user (e.g., seat positions).

In some implementations, the state module 208 updates the state data 295 based on a user response. The operation module 214 may perform an operation and in response, a user manually overrides the operation by stopping the operation, reversing the operation, or changing a target setting to a new setting. For example, where the operation module 214 determines that the target setting for a radio is to change a radio channel from 90.9 to 88.5, the user may override the operation by turning off the radio (stopping the operation), changing the radio channel back to 90.9 (reversing the operation), or changing the radio channel to 100.1 (changing the target setting to a new setting). The state module 208 may update the state data 295 for the target state by removing a target setting for the radio channel or replacing the target setting with the new setting. In some implementations, the state module 208 updates the state data 295 after the user manually overrides the operation a threshold number of times, for example, after a third time that the user manually overrides the operation. In some implementations, the state module 208 updates the state data 295 after the user provides a verbal response in addition to manually overriding the operation. For example, the state module 208 updates the state data 295 if the user manually overrides the operation and says “Wrong station!” as determined by the speech dialog module 216. In some implementations, the state module 208 updates the state data 295 after the user manually overrides the operation by verbally stating that an operation should be performed. For example, the state module 208 receives from the speech dialog module 216 via the communication module 202 that the user said to “Turn the AC on.”

The trigger module 210 determines whether the current state is a candidate to be changed to a target state. In some implementations, the trigger module 210 can include a set of instructions executable by the processor 225 to provide the functionality described below for determining whether the current state is the candidate to be changed to the target state. In some implementations, the trigger module 210 can be stored in the memory 227 of the automaticity device 200 and can be accessible and executable by the processor 225. The trigger module 210 is coupled to the bus 220 via signal line 211.

The trigger module 210 determines whether the current state is a candidate to be changed to a target state by comparing the current state to the target state. Responsive to determining that the current state is a candidate to be changed to the target state, the trigger module 210 may instruct the operation module 214 to determine an operation to change the current state to the target state.

In some implementations, the trigger module 210 uses pattern data to determine whether the current state is a candidate to be changed to a target state. The trigger module 210 may observe user actions, determine a pattern based on the user actions, determine a degree of automaticity for an operation, and update the pattern based on a user response. The trigger module 210 may determine the user response by processing the user data 291, the sensor data 293, and the state data 295 to identify instances where a user manually changed a current state to a target state. The trigger module 210 may update the operation data 299 and/or the automaticity data 297 based on the user response.

The trigger module 210 may determine whether to perform an operation based on a pattern where the current state is a threshold difference from a target state. For example, the trigger module 210 may determine that the user changes a seat position in a vehicle when the bottom of the seat is at least two inches away from the target setting and the top seat or backrest is at least 10 degrees away from the target setting. As a result, the trigger module 210 determines that an operation to change the seat position should be performed when the bottom seat is a threshold difference of two inches from the target setting or when the top seat is a threshold difference of 10 degrees from the target setting. Alternatively or additionally, the trigger module 210 may determine whether to perform an operation based on a pattern where the current state is anything other than the target state. For example, the trigger module 210 may determine that the target state is that the user listens to an FM radio program about the morning news and that the current state is that a stereo is set to play music from a satellite radio station. As a result, the trigger module 210 instructs the operation module 214 to change from the satellite radio station to the FM radio program.

In some implementations, the trigger module 210 may determine the pattern based on generalized data for users. For example, the trigger module 210 may determine that users prefer an average temperature of 65 degrees Fahrenheit. The trigger module 210 may determine generalized data for a subset of users. For example, the trigger module 210 may determine that users that are 5′5 prefer the mirrors to be set at certain angles. In some implementations, the pattern may be used to create a default target setting for new users that is further refined by a user response.

In some implementations, the trigger module 210 determines whether to perform an operation based on machine learning. For example, the trigger module 210 uses the user data 291, the sensor data 293, and the state data 295 to make predictions about whether performing the operation would be desirable to a user. The trigger module 210 may receive user data 291, sensor data 293, and state data 295 for multiple users and generate clusters based on the received data. The trigger module 210 may also receive user responses to the predictions and update the user data 291, the sensor data 293, and/or the state data 295 based on the user responses.

Other ways for determining whether to perform the operation are possible. For example, the trigger module 210 may use data mining to determine whether a user desires an automatic operation to be performed to change a current state to a target state.

In some implementations where the user identification module 206 determines that multiple users are in the vehicle, the trigger module 210 may determine whether to perform operations for both users. For example, the trigger module 210 may determine that the current state for one of the seats is a candidate to be changed to the target setting. In another example, where the vehicle is capable of providing different heated seat settings, the trigger module 210 may determine that a first seat should be heated to a first temperature and a second seat should be heated to a second temperature.

In some implementations, the trigger module 210 determines whether the current state is a candidate to be changed to a target state based on a context of the target state as determined by the state module 208. For example, the state module 208 may determine a target state for a user after the user visited the gym. The target state may include target settings, for example, a cooler temperature inside the vehicle and a rock music station.

The trigger module 210 may determine the degree of automaticity and instruct the automaticity module 212 to implement the degree of automaticity. For example, the trigger module 210 may determine a pattern of degrees of automaticity from user data 291 for users to determine generalized user preferences. The trigger module 210 may apply the pattern as a default and modify the degrees of automaticity based on a user response. For example, if the user manually overrides an automatic operation, the trigger module 210 may determine that that the user did not agree with the degree of automaticity. For example, if the user manually overrides the automatic operation but does not change a current setting, the user may want to manually perform the operation. Conversely, if the user manually overrides the automatic operation by changing the current setting, the user may desire a different target parameter. In some implementations where the degree of automaticity is set to not automatically performing the operation even though the trigger module 210 determines that the current state of the vehicle is a candidate to be changed to a target state, the trigger module 210 may change the degree of automaticity based on a user noticing that the operation was omitted and the user requesting that the operation be performed.

In some implementations, the trigger module 210 may start with a moderate degree of automaticity, for example, asking a user for permission before a first time an operation is performed and, if the user gives permission the first time, perform the operation automatically each subsequent time that the operation is performed.

In some implementations, the trigger module 210 determines whether performing the operation would create a safety hazard and, responsive to determining that performing the operation would create the safety hazard, the trigger module 210 determines that the operation should not be performed or the target settings should be different from what a user desires. For example, although the target settings for the user include that the user desires no headlights after dark, the trigger module 210 may still instruct the operation module 214 to turn on the headlights or partially modify the target setting by turning on the parking lights when the light outside begins to fade instead of turning on the headlights. In some implementations, responsive to determining that performing the operation would create the safety hazard, the trigger module 210 determines that the degree of automaticity is to not perform the operation. For example, if the user wants to turn off the lights when it is dark outside, the trigger module 210 may instruct the automaticity module 212 to not automatically perform the operation. In another example, the trigger module 210 may override a manual operation from the user to turn off the lights when it is dark outside to protect the user from a potential collision.

In some implementations, the trigger module 210 may instruct the operation module 214 to perform operations based on safety considerations where no target setting exists. For example, the trigger module 210 may instruct the operation module 214 to turn on headlights in a mountain region in California and the operation module 214 may instruct the automaticity module 212 to perform the operation automatically.

The automaticity module 212 can include code and routines for implementing a degree of automaticity. In some implementations, the automaticity module 212 can include a set of instructions executable by the processor 225 to implement the degree of automaticity. In some implementations, the automaticity module 212 can be stored in the memory 227 of the automaticity device 200 and can be accessible and executable by the processor 225. The automaticity module 212 is coupled to the bus 220 via signal line 213.

In some implementations, the automaticity module 212 receives instructions from the trigger module 210 to implement a degree of automaticity for an operation. The degrees of automaticity may include: determining to not perform an automatic operation; asking a user for permission before an operation is performed each time; asking a user for permission before a first time an operation is performed and, if the user gives permission the first time, performing the operation automatically each subsequent time that the operation is performed; automatically performing an operation while informing the user that the operation is being performed; automatically performing an operation; and triggering a related automatic operation. The automaticity module 212 may ask the user for permission to perform the operation by instructing the speech dialog module 216 to generate instructions for the speaker 233 to generate audio for playback or instructing the user interface module 218 to generate graphical data for displaying a user interface that includes a request for permission to perform the operation. The related automatic operation may include another operation that may change a current state to a target state. For example, if it is raining outside and the operation is turning on the windshield wipers, a related automatic operation may be turning on the headlights. The automaticity module 212 may generate automaticity data 297 that includes a degree of automaticity implemented at a particular time.

In some implementations, a first operation is associated with a first degree of automaticity and a second operation is associated with a second degree of automaticity, where the first degree of automaticity is different from the second degree of automaticity. For example, the operation module 214 may automatically turn on the headlights, but the automaticity module 212 may ask for permission to adjust the seat position, although both operations are being performed to achieve the same target state.

The operation module 214 can include code and routines for performing an operation. In some implementations, the operation module 214 can include a set of instructions executable by the processor 225 to provide the functionality described below for performing the operation. In some implementations, the operation module 214 can be stored in the memory 227 of the automaticity device 200 and can be accessible and executable by the processor 225. The operation module 214 is coupled to the bus 220 via signal line 213.

The operation module 214 receives instructions from the trigger module 210 to perform an operation. Alternatively, the operation module 214 receives instructions from the automaticity module 212 to perform an operation according to the degree of automaticity implemented by the automaticity module 212. The operation module 214 may determine what operation to perform. For example, where the temperature in the vehicle is too hot, the operation module 214 may determine whether to lower the temperature by turning on the air conditioning or by opening a window. In addition, the operation module 214 may determine an extent of an operation. For example, the operation module 214 may determine what level of air conditioning to use or how much to open the window to lower the temperature of the vehicle.

The speech dialog module 216 can include code and routines for generating instructions for the speaker 233 to generate audio for playback and performing speech recognition. In some implementations, the speech dialog module 216 can include a set of instructions executable by the processor 225 to provide the functionality described below for generating instructions for the speaker 233 to generate audio for playback and performing speech recognition. In some implementations, the speech dialog module 216 can be stored in the memory 227 of the automaticity device 200 and can be accessible and executable by the processor 225. The speech dialog module 216 is coupled to the bus 220 via signal line 217.

In some implementations, the speech dialog module 216 receives instructions from the trigger module 210 to generate instructions for the speaker 233 to generate audio for playback. For example, the audio for playback may include asking a user for permission to perform an operation. In another example, the audio for playback may be part of a degree of automaticity where the audio warns the user about an operation that is about to occur (e.g., “Let me open the windows for you.”). The speech dialog module 216 may be configured to generate audio in different languages, with different accents, etc.

The speech dialog module 216 may receive a verbal response from the user and may determine whether the verbal response includes permission to perform the operation. The speech dialog module 216 determines whether the verbal response includes permission by performing speech recognition. In some implementations, the speech recognition is based on natural language processing. For example, the speech dialog module 216 performs speech recognition to identify the words spoken by the user and compares the words to lists to determine whether the words match a list for giving permission or denying permission. In some implementations, the speech dialog module 216 recognizes key phrases. For example, the speech dialog module 216 may recognize the key phrase “Do not do that.” If the user gives permission to perform the operation, the speech dialog module 216 may instruct the operation module 214 to perform the operation.

In some implementations, the speech dialog module 216 may receive a verbal response from a user and determine a reaction from the user to at least one of the operation and the degree of automaticity. For example, the speech dialog module 216 may receive instructions from a user that manually override an operation. For example, after the AC is turned off or set to a relatively higher temperature, the user may say “Turn the AC on” to instruct the operation module 214 to lower the temperature inside the vehicle using the air conditioning. The speech dialog module 216 may perform natural language processing to identify the reaction and transmit the instruction to the operation module 214 via the communication module 202. In another example, the speech dialog module 216 may receive a positive response from the user. For example, the user may say “Thanks!” to the operation module 214 automatically locking the doors after the user switches the vehicle from park to drive. The speech dialog module 216 may transmit the positive response to the trigger module 210, which updates the operation data 299 with the positive response.

The user interface module 218 can include code and routines for generating graphical data for providing user interfaces. In some implementations, the user interface module 218 can include a set of instructions executable by the processor 225 to provide the functionality described below for generating graphical data for providing user interfaces. In some implementations, the user interface module 218 can be stored in the memory 227 of the automaticity device 200 and can be accessible and executable by the processor 225. The user interface module 218 is coupled to the bus 220 via signal line 219.

In some implementations, the user interface module 218 receives instructions from the trigger module 210 to generate graphical data for displaying a user interface that includes a request for permission to perform an operation. The user interface module 218 may receive user input from the user giving permission or denying permission. If the user gives permission to perform the operation, the user interface module 218 may instruct the operation module 214 via the communication module 202 to perform the operation. The user interface module 218 may also update the automaticity data 297 with information about the user giving permission to perform the operation.

### Example User Interface

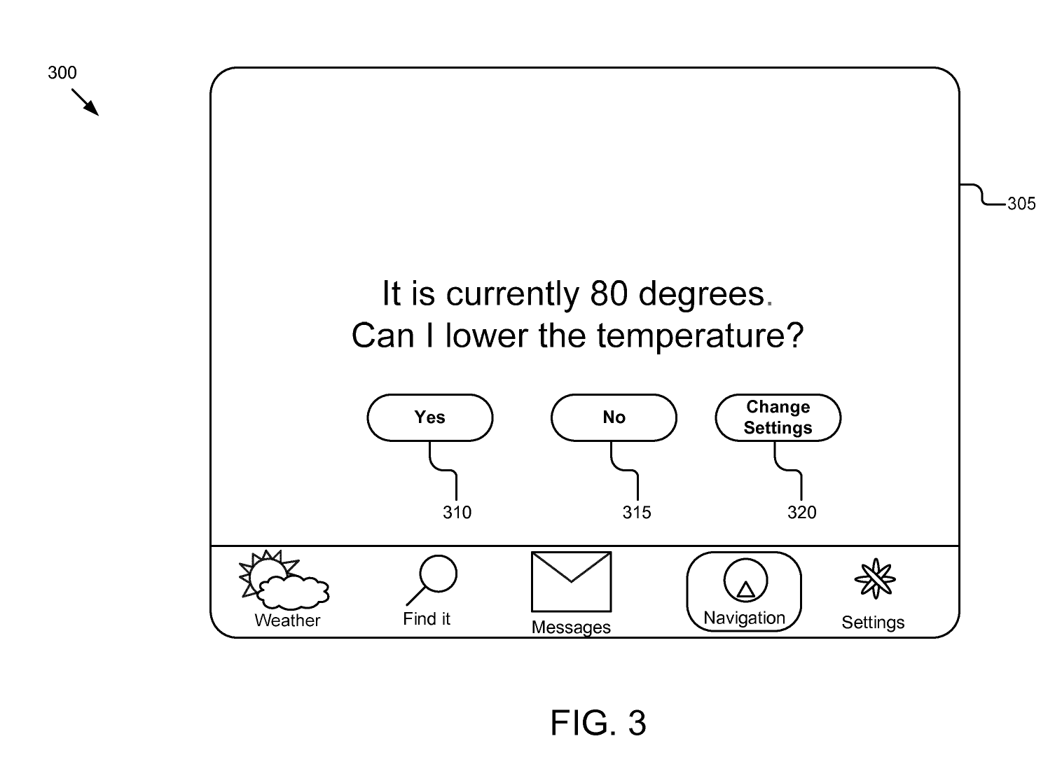

FIG. 3 is a graphic representation of an example user interface 300 for asking a user for permission to perform an operation. The user interface 300 includes a screen 305 generated by the user interface module 218 that asks a user for permission to lower the temperature in a vehicle. The user may select a “Yes” button 310, a “No” button 315, or a “Change Settings” button 320. The “Change Settings” button 320 might include, for example, an option to change the degree of automaticity for the operation or to change an associated target state.

### Example Method

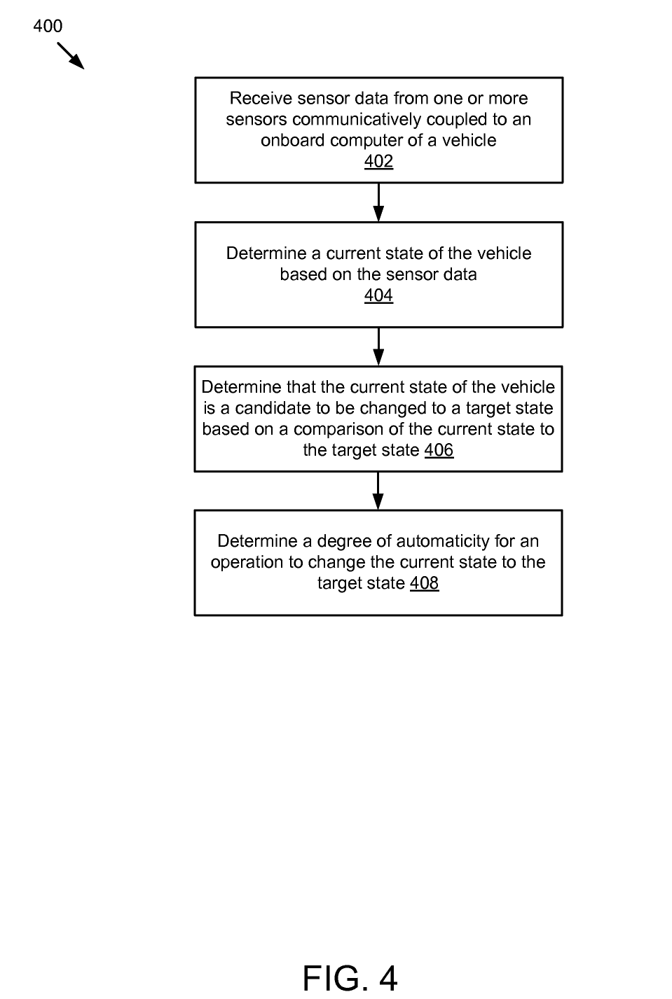

FIG. 4 is a flowchart of an example method 400 for determining a degree of automaticity for a vehicle operation. In some implementations, the method 400 may be performed by modules of the automaticity application 199 stored on the first client device 103, the mobile client device 188, or the automaticity device 200. For example, the automaticity application 199 may include the state module 208 and the trigger module 210.

The state module 208 receives 402 sensor data 293 from one or more sensors 235 communicatively coupled to an onboard computer of a vehicle via the communication module 202. For example, the state module 208 receives sensor data 293 from a thermometer inside the vehicle. The state module 208 determines 404 a current state of the vehicle based on the sensor data 293. For example, the state module 208 determines that the temperature inside the vehicle is 80 degrees Fahrenheit. The trigger module 210 determines 406 that the current state of the vehicle is a candidate to be changed to a target state based on a comparison of the current state to the target state. For example, the trigger module 210 determines that the target state of the vehicle is 75 degrees Fahrenheit. The trigger module 210 may determine that the current state of the vehicle is a candidate to be changed based on pattern data. For example, the trigger module 210 may determine from state data 295 that in the past when the temperature reaches 80 degrees Fahrenheit inside the vehicle, the user has manually changed the temperature to be 75 degrees Fahrenheit.

The trigger module 210 determines 408 a degree of automaticity for an operation to change the current state to the target state. For example, the trigger module 210 determines that the degree of automaticity is to automatically perform the operation or to ask the user for permission to lower the temperature. In some implementations, the trigger module 210 determines the degree of automaticity based on a pattern. In some implementations, the trigger module 210 applies a default degree of automaticity and revises the degree of automaticity accordingly based on a user response (or absence of a user response) to performing the operation with the default degree of automaticity.

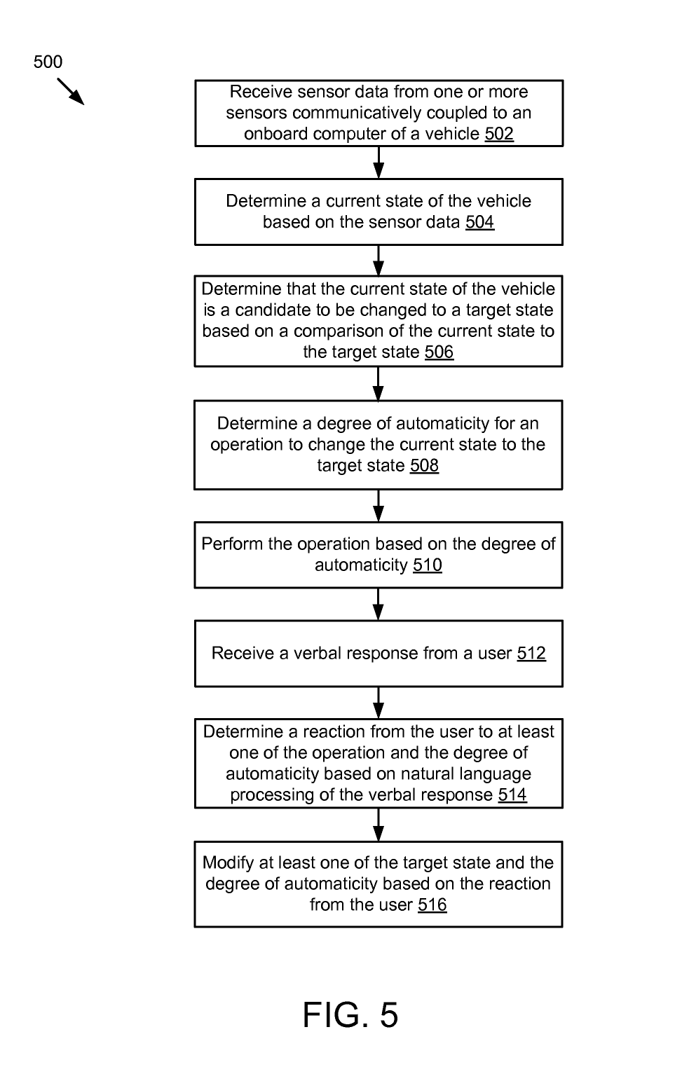

FIG. 5 is a flowchart of an example method 500 for modifying a degree of automaticity based on a user's response to a vehicle operation. In some implementations, the method 500 may be performed by modules of the automaticity application 199 stored on the first client device 103, the mobile client device 188, or the automaticity device 200. For example, the automaticity application 199 may include the state module 208, the trigger module 210, the automaticity module 212, the operation module 214, and the speech dialog module 216.

The state module 208 receives 502 sensor data 293 from one or more sensors 235 communicatively coupled to an onboard computer of a vehicle via the communication module 202. For example, the state module 208 receives sensor data 293 from a clock that identifies a current time and an audio sensor that identifies what the user may be listening to. The state module 208 determines 504 a current state of the vehicle based on the sensor data 293. For example, the state module 208 determines that the current time is 10 a.m. and the audio system is set to play a streaming radio program about travel.

The trigger module 210 determines 506 that the current state of the vehicle is a candidate to be changed to a target state based on a comparison of the current state to the target state. For example, the trigger module 210 determines that the target state of the vehicle at 10 a.m. is to play the morning news. The trigger module 210 may determine that the current state of the vehicle is a candidate to be changed based on pattern data. For example, the trigger module 210 may determine a pattern that at 10 a.m. the user listens to the morning news 90% of the time. Because the audio system is set to play the streaming radio program about travel, the audio system should be changed to play the morning news. The trigger module 210 determines 508 a degree of automaticity for an operation to change the current state to the target state. For example, the trigger module 210 determines that a default setting for the degree of automaticity is to automatically switch the audio system to play the morning news.

The operation module 214 performs 510 the operation based on the degree of automaticity. For example, the operation module 214 instructs the audio system to switch from the streaming radio program about travel to the morning news.

The speech dialog module 216 receives 512 a verbal response from the user. For example, the user says “Quit that!” The speech dialog module 216 determines 514 a reaction from the user to at least one of the operation and the degree of automaticity based on natural language processing of the verbal response. For example, the speech dialog module 216 identifies words in the verbal response and compares the words to lists of words to determine whether the reaction is negative or positive. In this example, the speech dialog module 216 would compare “quit” and “that” to the lists of words and determine that “quit” is a negative response. The trigger module 210 or the state module 208 modifies 516 at least one of the target state and the degree of automaticity based on the reaction from the user. For example, the trigger module 210 may change the degree of automaticity from automatically performing the operation to asking permission before performing the operation.

The descriptions of the specification can also relate to an apparatus for performing the operations herein. This apparatus may include the user of a special-purpose or general-purpose computer including various computer hardware of software modules. Implementations described herein may be implemented using a computer program stored in the computer. Such a computer program may be stored in a non-transitory computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations, or some implementations containing both hardware and software elements. In some implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those that practice the art of computer programming. Additionally, the disclosure is in no way limited to implementations in any specific programming language, or for any specific operating system or environment. Accordingly, the disclosure is intended to be illustrative, but not limiting, of the scope of the specification, which is set forth in the following claims.

What is claimed is:

1. A method comprising:
receiving sensor data from one or more sensors communicatively coupled to a processor-based computing device of a mobile system;
determining a current state of the mobile system based on the sensor data;
determining that the current state of the mobile system is a candidate to be changed to a target state based on a comparison of the current state to the target state; and
determining, by the processor-based computing device programmed to perform the determining, a degree of automaticity for an operation to change the current state of the mobile system to the target state.

2. The method of claim 1, wherein the degree of automaticity includes asking a user for permission to perform the operation, the method further comprising:
generating audio for playback in a speaker of the mobile system to ask the user for permission to perform the operation;
receiving a verbal response to the audio from the user;
determining whether the verbal response includes permission to perform the operation; and
responsive to the verbal response including permission to perform the operation, performing the operation.

3. The method of claim 1, wherein the degree of automaticity includes asking a user for permission to perform the operation, the method further comprising generating graphical data for displaying a user interface that includes a request for permission to perform the operation.

4. The method of claim 1, wherein the degree of automaticity includes asking a user for permission to perform the operation a first time, the method further comprising responsive to the user providing permission, performing the operation automatically each subsequent time that the current state of the mobile system is determined to be the candidate to be changed to the target state.

5. The method of claim 1, further comprising:
performing the operation according to the degree of automaticity;
determining a user manually overriding the operation by stopping the operation or reversing the operation; and
modifying at least one of the target state and the degree of automaticity based on the user manually overriding the operation.

6. The method of claim 1, further comprising:
performing the operation according to the degree of automaticity;
determining a user manually overriding the operation by modifying a target setting associated with the target state to a new setting; and
modifying the target state by replacing the target setting with the new setting.

7. The method of claim 1, wherein a first operation is associated with a first degree of automaticity and a second operation is associated with a second degree of automaticity, the first degree of automaticity being different from the second degree of automaticity.

8. The method of claim 1, further comprising:
determining whether performing the operation would create a safety hazard; and
responsive to determining that performing the operation would create the safety hazard, determining that the degree of automaticity includes not performing the operation.

9. The method of claim 1, further comprising:
storing a first record of sensor data responsive to a user performing a manual operation; and
determining the target state based on the sensor data in the record.

10. The method of claim 9, further comprising storing a second record of sensor data a predetermined amount of time before the user performs the manual operation, and wherein determining the target state further comprises comparing the first record of sensor data to the second record of sensor data.

11. A non-transitory computer-readable medium having computer instructions stored thereon that are executable by a processing device to perform or control performance of steps comprising:
receiving sensor data from one or more sensors communicatively coupled to a processor-based computing device of a mobile system;
determining a current state of the mobile system based on the sensor data;
determining that the current state of the mobile system is a candidate to be changed to a target state based on a comparison of the current state to the target state; and
determining a degree of automaticity for an operation to change the current state of the mobile system to the target state.

12. The non-transitory computer-readable medium of claim 11, wherein the degree of automaticity includes asking a user for permission to perform the operation, the steps further comprising:
generating audio for playback in a speaker of the mobile system to ask the user for permission to perform the operation;
receiving a verbal response to the audio from the user;
determining whether the verbal response includes permission to perform the operation; and
responsive to the verbal response including permission to perform the operation, performing the operation.

13. The non-transitory computer-readable medium of claim 11, wherein the degree of automaticity includes asking a user for permission to perform the operation, the steps further comprising generating graphical data for displaying a user interface that includes a request for permission to perform the operation.

14. The non-transitory computer-readable medium of claim 11, wherein the degree of automaticity includes asking a user for permission to perform the operation a first time, the steps further comprising responsive to the user providing permission, performing the operation automatically each subsequent time that the current state of the mobile system is determined to be the candidate to be changed to the target state.

15. The non-transitory computer-readable medium of claim 11, the steps further comprising:
performing the operation according to the degree of automaticity;
determining a user manually overriding the operation by stopping the operation or reversing the operation; and
modifying at least one of the target state and the degree of automaticity based on the user manually overriding the operation.

16. The non-transitory computer-readable medium of claim 11, the steps further comprising:
performing the operation according to the degree of automaticity;
determining a user manually overriding the operation by modifying a target setting associated with the target state to a new setting; and
modifying the target state by replacing the target setting with the new setting.

17. The non-transitory computer-readable medium of claim 11, wherein a first operation is associated with a first degree of automaticity and a second operation is associated with a second degree of automaticity, the first degree of automaticity being different from the second degree of automaticity.

18. The non-transitory computer-readable medium of claim 11, the steps further comprising:
determining whether performing the operation would create a safety hazard; and
responsive to determining that performing the operation creates the safety hazard, determining that the degree of automaticity includes not performing the operation.

19. The non-transitory computer-readable medium of claim 11, the steps further comprising:
storing a first record of sensor data responsive to a user performing a manual operation; and
determining the target state based on the sensor data in the record.

20. A method comprising:
receiving sensor data from one or more sensors communicatively coupled to an onboard computer of a vehicle;
determining a current state of the vehicle based on the sensor data;
determining that the current state of the vehicle is a candidate to be changed to a target state based on a comparison of the current state to the target state;
determining, by a processor-based computing device programmed to perform the determining, a degree of automaticity for an operation to change the current state of the vehicle to the target state;
performing the operation according to the degree of automaticity;
receiving a verbal response from a user;
determining a reaction from the user to at least one of the operation and the degree of automaticity based on natural language processing of the verbal response; and
modifying at least one of the target state and the degree of automaticity based on the reaction from the user.
